(19) United States
(12) Patent Application Publication
(10) Pub. No.: US 2012/0162260 A1
(43) Pub. Date: Jun. 28, 2012

(54) MANAGING PROJECTED IMAGES ON A PROJECTION SURFACE

(75) Inventors: Gary D. Cudak, Research Triangle Park, NC (US); Randall C. Humes, Research Triangle Park, NC (US); Christopher J. Hardee, Research Triangle Park, NC (US); Heather C. Miller, Research Triangle Park, NC (US)

(73) Assignee: INTERNATIONAL BUSINESS MACHINES CORPORATION, Armonk, NY (US)

(21) Appl. No.: 12/979,711

(22) Filed: Dec. 28, 2010

(51) Int. Cl. G09G 5/00

(52) U.S. Cl. 345/647

(57) ABSTRACT

An apparatus, method, and system for managing projected images on a projection surface. One embodiment of the apparatus includes a sensor module, a determination module, and an interference module. The sensor module is configured to sense a projected image displayed on a projection surface. The projected image is projected from a projector. The determination module is configured to determine whether the projector is authorized to project the projected image on the projection surface in response to the sensor module sensing the projected image projected on the projection surface. The interference module is configured to interfere with a display of the projected image in response to the determination module determining that the projector is not authorized to project the projected image on the projected surface. The interference module alters the display of at least a portion of the projected image.

### BACKGROUND

1. Field

The subject matter disclosed herein relates to projected images on a projection surface and more particularly relates to managing projected images on a projected surface.

2. Description of the Related Art

Technological advances in projectors have led to smaller projectors with high quality projected images. Furthermore, certain portable electronic devices include integrated projectors, allowing the projected image to act as the monitor for the portable electronic device and display the applications that the user is executing on the computing device. As a result, smooth surfaces in airports, malls, storefronts, and the like, may be used to display projected images from advertisers, users, property owners, and others.

However, in certain instances, allowing projected images may not be desirable in all cases and it may be preferred to offer them for a cost, to disable them for human traffic flow purposes in a crowded area, to disallow projected advertising, and the like.

### BRIEF SUMMARY

From the foregoing discussion, it should be apparent that a need exists for an apparatus, method, and system that authorize a projector to project a projected image onto a projection surface. Beneficially, such an apparatus, method, and system would interfere with a display of the projected image when the projector is not authorized.

The present subject matter has been developed in response to the present state of the art, and in particular, in response to the problems and needs in the art that have not yet been fully solved by currently available projection systems. Accordingly, the present subject matter has been developed to provide an apparatus, method, and system for managing projected images on a projected surface that overcome many or all of the above-discussed shortcomings in the art.

One embodiment of an apparatus for managing projected images on a projection surface is provided with a plurality of modules configured to functionally execute the steps of sensing a projected image, determining whether the projector is authorized to project the projected image, and interfering with a display of the projected image. These modules include a sensor module, a determination module, and an interference module.

The sensor module is configured to sense a projected image displayed on a projection surface. The projected image is projected from a projector. The determination module is configured to determine whether the projector is authorized to project the projected image on the projection surface in response to the sensor module sensing the projected image projected on the projection surface. The interference module is configured to interfere with a display of the projected image in response to the determination module determining that the projector is not authorized to project the projected image on the projected surface. The interference module alters the display of at least a portion of the projected image.

One embodiment of a method is also presented for managing projected images on a projection surface. The method in the disclosed embodiments may substantially include the steps necessary to carry out the functions presented above with respect to the operation of the described apparatus. In one embodiment, the method includes sensing a projected image displayed on a projection surface. The projected image is projected from a projector. The method includes determining whether the projector is authorized to project the projected image on the projection surface in response to sensing the projected image projected on the projection surface. The method also includes interfering with a display of the projected image in response to determining that the projector is not authorized to project the projected image on the projected surface. Interfering with the display further includes altering the display of at least a portion of the projected image.

One embodiment of a system is also presented for managing projected images on a projection surface. The system may be embodied as a sensor, one or more processors in communication with the sensor, a sensor module executing on at least one of the processors, a determination module executing on at least one of the processors, and an interference module executing on at least one of the processors.

The sensor module is configured to sense, using the sensor, a projected image displayed on a projection surface. The projected image is projected from a projector. The determination module is configured to determine whether the projector is authorized to project the projected image on the projection surface in response to the sensor module sensing the projected image projected on the projection surface. The interference module is configured to interfere with a display of the projected image in response to the determination module determining that the projector is not authorized to project the projected image on the projected surface. The interference module alters the display of at least a portion of the projected image.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the present subject matter will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for managing projected images on a projection surface;

FIG. 2 is a schematic block diagram illustrating the system of FIG. 1 with one embodiment of the project management apparatus interfering with a display of a projected image;

FIG. 3 is a schematic block diagram illustrating one embodiment of a projection management apparatus;

FIG. 4 is a detailed schematic block diagram illustrating an embodiment of a projection management apparatus and an embodiment of an authorization apparatus;

FIG. 5A is a schematic block diagram illustrating one embodiment of interference with a projected image on a projection surface;

FIG. 5B is a schematic block diagram illustrating another embodiment of interference with a projected image on a projection surface;

FIG. 6 is a schematic flow chart diagram illustrating one embodiment of a method for managing projected images on a projection surface;

FIG. 7 is a detailed schematic flow chart diagram illustrating another embodiment of a method for managing projected images on a projection surface; and

FIG. 8 is a schematic flow chart diagram illustrating one embodiment of a method for interfering with a projected image on a projection surface.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

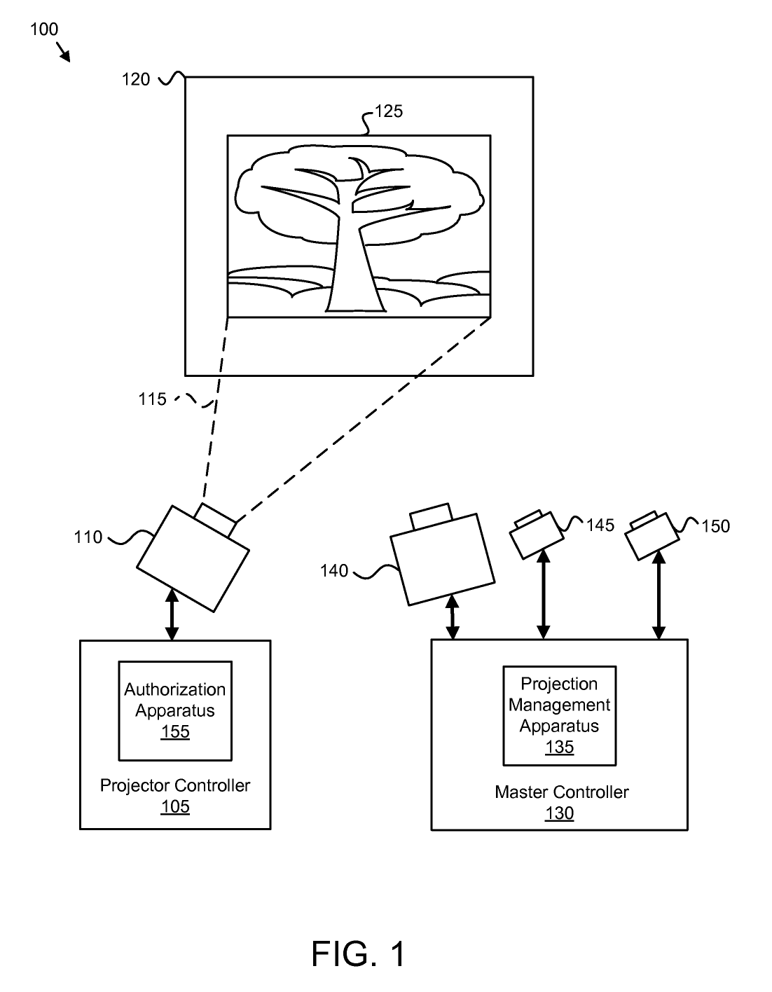

FIG. 1 illustrates one embodiment of a system 100 for managing projected images on a projection surface. The system 100 includes a projector controller 105 and a projector 110 that projects 115 a projected image 125 onto a projection surface 120. Furthermore, the system 100 also includes a master controller 130, a master projector 140, a sensor 145, and a scanner 150. In addition, the projector controller 105 includes an authorization apparatus 155.

The projector controller 105 controls operation of the projector 110. The projector controller 105 may be embodied as a computing device. Specifically, the projector controller 105 may include a portable electronic device such as a touch device, a personal desktop assistant (“PDA”), a tablet computer, a Smartphone, and the like. The projector controller 105 may also include a personal computer, a server, and the like.

In the depicted embodiment, the projector 110 is separately embodied from the projector controller 105. In alternate embodiments, the projector 110 is integrated with the projector controller 105. For example, the projector 110 and the projector controller 105 may comprise a hand-held computing device with an embedded projector 110 or, likewise, a projector 110 with an embedded computing device. In one embodiment, the projector controller 105 and/or the projector 110 includes one or more processors that may execute computer readable programs as is known to those skilled in the art. For example, the projector controller 105 may include a memory storing the computer readable programs which the processor may execute.

The projector 110 may comprise any suitable projector 110 capable of projecting 115 an image 125 onto a projection surface 120 including but not limited to a digital projector, video projector, cathode ray tube (“CRT”) projector, liquid crystal display (“LCD”) projector, liquid crystal on silicon (“LCOS”) projector, light-emitting diode (“LED”) projector, and/or the like. The projector 110 and/or an additional projector in communication with the projector controller 105 may also be configured to project infrared light, ultraviolet (“UV”) light, and/or any suitable non-visible (to the human eye) light as is described below. The projection surface 120 may be any surface suitable to display a projected image 125.

The master controller 130 may be embodied as a computing device. Specifically, the master controller 130 may include a personal computer, a server, and the like. The master controller 130 may include one or more processors that execute computer readable programs as is known to those skilled in the art.

The master controller 130 includes a projection management apparatus 135. The projection management apparatus 135 may manage projected images 125 on the projection surface 120. Specifically, the projection management apparatus 135 may be in communication with a sensor 145 to sense a projected image 125. Once the projection management apparatus 135 senses the projected image 125, the projection management apparatus 135 may determine whether the projector 110 that is projecting 115 the projected image 125 is authorized to project 115 the projected image 125.

The projection management apparatus 135 may authorize a projector 110 based a projection from the projector 110 (e.g. on the projected image 125 and/or an addition image projected by the projector 110), after scanning the projection surface 120 and corresponding projected images 125 with the scanner 150. Although the sensor 145 and the scanner 150 are depicted as separate elements, in certain embodiments, the sensor 145 and scanner 150 may be embodied in a single device. Furthermore in one embodiment, the sensor 145 may be embedded in the projection surface 120 to sense the projected image 125.

The projection management apparatus 135 may recognize an authorization pattern projected from the projector 110 onto the projection surface 120 and authorize the projector 110. The projection management apparatus 135 may communicate authorization pattern information to the projector 110, which may project 115 the authorization pattern based on the authorization pattern information. As a result, the projection management apparatus 135 may verify that the projected image 125 originates from the projector 110 with which it communicated authorization pattern information.

In the depicted embodiment, the projector controller 105 includes an authorization apparatus 155 to facilitate identification of the projector 110 by the master controller 130. The authorization apparatus 155 may receive the authorization information from the master controller 130. The authorization apparatus 155 may also generate the authorization pattern which is projected onto the projection surface 120 by the projector 110.

If the projection management apparatus 135 does not authorize the projector 110, the projection management apparatus 135 may interfere with a display of the projected image 125 of the projector 110. The projection management apparatus 135 may interfere with the display by altering the projection surface 120 (e.g. moving a covering over the projection surface 120, shining a light on the projection surface 120, and the like).

In addition, the projection management apparatus 135 may also interfere with the display by projecting a second projected image 210 over the projected image 125 using a second projector (such as the master projector 140) to interfere with the display of the projected image 125 as described below. Consequently, the projection management apparatus 135 allows a user to control, limit, and or manage projections on the projection surface 120. Furthermore, although a single projection surface 120 is depicted, the projection management apparatus 135 may, in certain embodiments, manage projections on multiple projection surfaces 120.

All or a portion of the projection management apparatus 135 may be stored on the memory and executed by at least one processor. In addition, all or a portion of the projection management apparatus 135 may be implemented as logic hardware. Furthermore, although in the depicted embodiment, the projection management apparatus 135 resides in the master controller 130, in other embodiments, all or a portion of the projection management apparatus 135 may reside in an external device in communication with the master controller 130.

Likewise, all or a portion of the authorization apparatus 155 may be stored on the memory and executed by at least one processor. In addition, all or a portion of the authorization apparatus 155 may be implemented as logic hardware. Furthermore, although in the depicted embodiment, the authorization apparatus 155 resides in the projector controller 105, in other embodiments, all or a portion of the authorization apparatus 155 may reside in the projector 110 and/or an external device in communication with the projector controller 105.

The master projector 140, sensor 145, and/or scanner 150 may be in communication with the master controller 130 and/or one or more processors of the master controller 130. In the depicted embodiment, the master projector 140, the sensor 145, and the scanner 150 are separately embodied from the master controller 130. In alternate embodiments, the master projector 140, sensor 145, and/or scanner 150 are integrated with the master controller 130. Furthermore, in certain embodiments, the master projector 140 is mobile, being mounted such that it may move in various directions and/or swivel to allow for the master projector 140 to access various angles of the projection surface 120 and/or additional projection surfaces 120. Furthermore, although a single master projector 140 is depicted, one or more additional master projectors 140 may also be used by the projection management apparatus 135.

The sensor 145 and/or scanner 150 may sense a projected image 125 by detecting illumination above a threshold, movement, changes in color above a threshold, and/or the like. The sensor 145 and/or scanner 150 may also be mounted such that the sensor 145 and/or scanner 150 may move in various directions as well as a swivel to allow for the sensor 145 and/or scanner 150 to access various angles of the projection surface 120 and/or additional projection surfaces 120. Furthermore, although a single sensor 145 and a single scanner 150 are depicted, one or more additional sensors 145 and/or scanners 150 may also be used by the projection management apparatus 135.

The sensor 145 and/or scanner 150 may include an optical scanner that optically scans the projection surface 120 and/or projected image 125 into a digital image. The sensor 145 and/or scanner 150 may include a digital camera that photographs and/or records a video stream of the projection surface 120. In other embodiments, the sensor 145 and/or scanner 150 may include photoelectric sensors, spectral sensors, ultrasonic sensors, and the like. In one embodiment, the sensor 145 and/or scanner 150 is capable of scanning infrared light, UV light and/or other non-visible light.

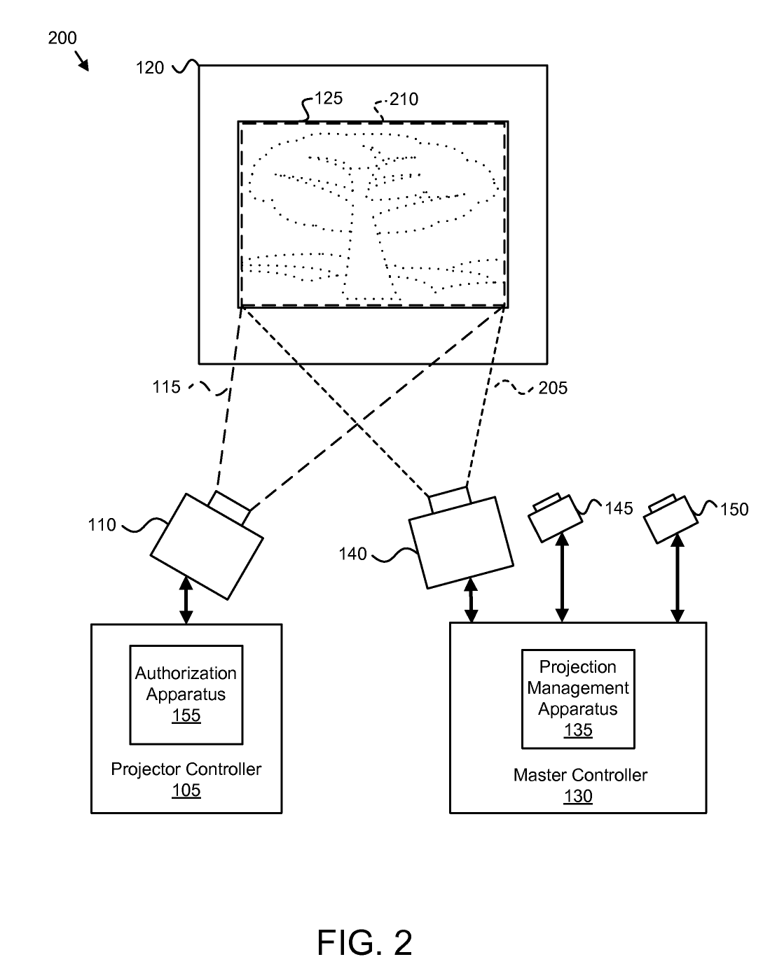

FIG. 2 illustrates a system 200 similar to the system 100 of FIG. 1 with one embodiment of the projection management apparatus 135 interfering with a display of a projected image 125. Specifically, the master projector 140 projects 205 a second image on the projection surface 120 over the projected image 125, interfering with a display of the projected image 125. In FIG. 2, the master projector 140 projects additive colors in the second projected image 210 that mix with colors of the projected image 125 to neutralize the display of the projected image 125.

By projecting additive colors on top of projected colors, the projection management apparatus 135 may vary the colors in the display on projection surface 120. Red, green and blue projected light may be mixed in various degrees on a projection surface to produce a full gamut of colors. Likewise, mixing red, green, and blue light in equal amounts yields white. Consequently, colors projected over other projected colors, referred to herein as additive colors, may alter the display of a projected image 125.

In the depicted embodiment, the projection management apparatus 135 projects additive colors to neutralize the display of the projected image 125. The scanner 150 may scan the display on the projection surface 120 and the projection management apparatus 135 may determine a displayed color at various locations of the display, determine an additive color corresponding to each displayed color at the various locations, and project with the master projector 140, a second projected image 210 with the additive colors to neutralize the display of the projected image 125. Neutralizing the display may comprise changing the display or a portion of the display to substantially white or to another solid color, producing a pattern on the display with additive colors, and the like. Other embodiments of an interfering second projected image 210 are described below.

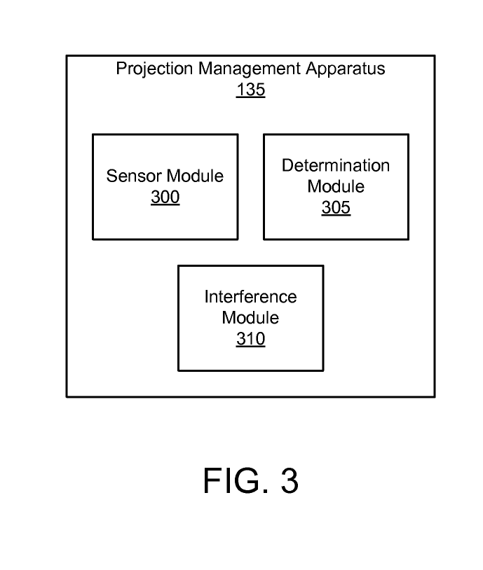

FIG. 3 illustrates one embodiment of the projection management apparatus 135 depicted in FIG. 1 and FIG. 2. The description of the apparatus 135 refers to elements of FIG. 1 and FIG. 2, like numbers referring to like elements. The apparatus 115 includes a sensor module 300, a determination module 305, and an interference module 310.

The sensor module 300 senses a projected image 125 displayed on a projection surface 120, the projected image 125 projected from a projector 110. The sensor module 300 may sense the projected image 125 using one or more sensors 145 and/or scanners 150. As described above, the sensor 145 and/or scanner 150 may include an optical scanner that optically scans the projection surface 120 into a digital image, a digital camera that photographs and/or captures a video stream of the projection surface 120, and the like.

In one embodiment, the sensor module 300 analyzes a digital image/video stream from the sensor 145/scanner 150 to detect changes in the digital image from a baseline digital image. Specifically, the sensor 145 and/or scanner 150 may capture a baseline image of the projection surface 120. The sensor module 300 may then compare subsequently captured images with the baseline image to detect changes that may be indicative of a projected image 125. In one embodiment, the sensor module 300 senses the projected image 125 displayed on the projection surface 120 in response to an illumination above a threshold, movement, changes in color above a threshold, and/or the like. In certain embodiments, the sensor module 300 disregards the existence of common discrepancies such as shadows and reflections.

The determination module 305 determines whether the projector 110 is authorized to project the projected image 125 on the projection surface 120 in response to the sensor module 300 sensing the projected image 125 projected on the projection surface 120. The sensor module 300 may signal the determination module 305 once the sensor module 300 detects a projected image 125.

The determination module 305 may determine authorization based on a time of day, a rental plan, an identity of one or more viewers in vicinity of the projection surface 120 (such as through biometrics and/or other means), and/or an identity of a projection user (such as through biometrics and/or other means). For example, the determination module 305 may receive an indication from the sensor module 300 of a projected image 125. The determination module 305 may determine that a current time falls within an allotted time in which all projections are allowed, and the determination module 305 may determine that the projector 110 is authorized to project the projected image 125.

In one embodiment, the determination module 305 determines authorization based on an identity of the projector 110 that corresponds to the sensed projected image 125. The determination module 305 may confirm that a projected image 125 originates from an authorized projector 110 by recognizing an authorization pattern projected by the projector 110. As described below, the authorization pattern may include a unique projector identifier projected onto the projection surface 120, recognizable for validation by the determination module 305. In one embodiment, the determination module 305 maintains a list of authorized projectors 110 with corresponding projector identifiers. The determination module 305 may, after identifying a particular projector 110 from a projector identifier, determine whether the projector identifier appears in the authorized projector list.

The authorization pattern may include a symbol, character, character string, and/or other suitable pattern. The authorization pattern may include a pattern generated by the projector 110 based on authorization pattern information communicated to authorized projectors 110 as is described below.

The interference module 310 interferes with a display of the projected image 125 in response to the determination module 305 determining that the projector 110 is not authorized to project the projected image 125 on the projected surface. In one embodiment, the interference module 310 alters the display of at least a portion of the projected image 125. The interference module 310 may alter the display of the portion of the projected image 125 by facilitating projection of a second projected image 210 over at least a portion of the display of the projected image 125 to interfere with the display of the projected image 125.

The interference module 310 may, in certain embodiments, alter the projected image 125 by altering the projection surface 120 itself as described below. For example, the interference module 310 may signal a mechanism to mechanically alter the projection surface 120 to disrupt the display of the projected image 125.

In one embodiment, the interference module 310 stops interfering with the display of the projected image 125 in response to the determination module 305 determining that the projector 110 is authorized to project the projected image 125 on the projected surface. If the determination module 305, at some future time, determines that the projector 110 is authorized, the determination module 305 may signal the interference module 310 to discontinue interfering with the projected image 125.

In some embodiments, the interference module 310 discontinues interfering in response to the sensor module 300 failing to detect a projected image 125. In one embodiment, the interference module 310 discontinues interfering after a predetermined time period.

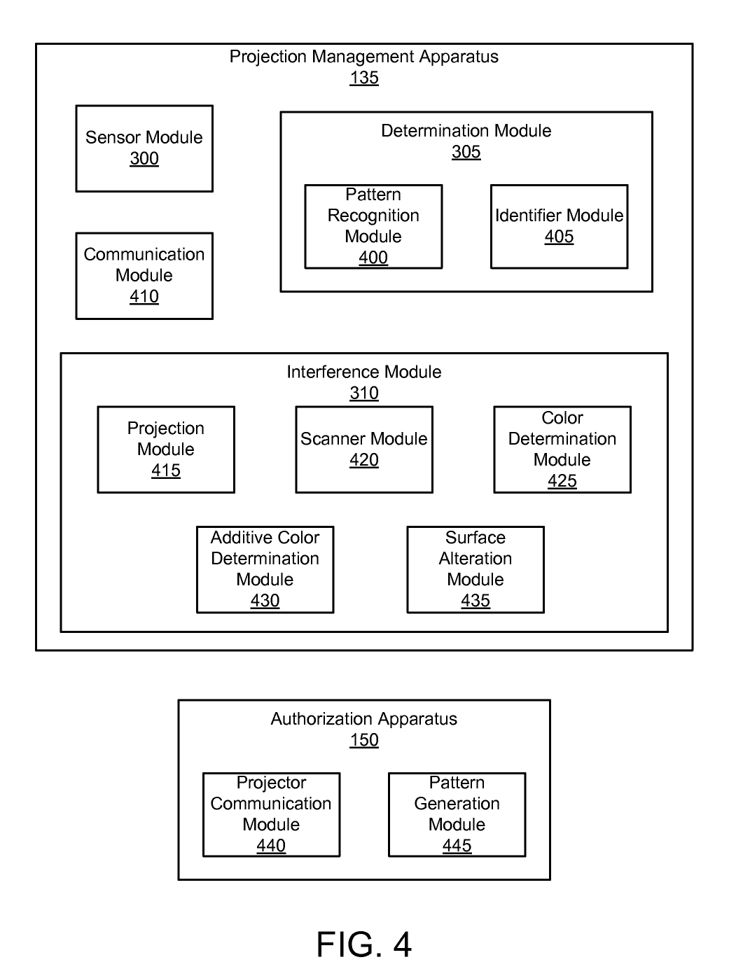

FIG. 4 illustrates a detailed embodiment of the projection management apparatus 135 and the authorization apparatus 155 depicted in FIG. 1 and FIG. 2. The description of the apparatus 135 and the apparatus 155 refers to elements of FIGS. 1-3, like numbers referring to like elements. The apparatus 135 includes the sensor module 300, the determination module 305, and the communication module 410, which are similar to the like-named modules described in relation to FIG. 3. In addition, the determination module 305 further includes a pattern recognition module 400 and an identifier module 405 and the interference module 310 further includes a projection module 415, a scanner module 420, a color determination module 425, an additive color determination module 430, and a surface alteration module 435. In addition, the authorization apparatus 155 includes a projector communication module 440 and a pattern generation module 445.

The pattern recognition module 400 recognizes an authorization pattern projected from the projector 110 onto the projection surface 120. In one embodiment, the determination module 305 determines that the projector 110 is authorized to project the projected image 125 on the projection surface 120 in response to the pattern recognition module 400 recognizing the authorization pattern projected from the projector 110 onto the projection surface 120. As stated above, the authorization pattern may include a symbol, character, character string, and/or other suitable pattern. The authorization pattern may include a single symbol and/or pattern, or multiple symbols/patterns displayed in sequence. The pattern recognition module 400 may include and/or be in communication with the scanner 150 and/or sensor 145 to scan the projection surface 120 for the authorization pattern projected from the projector 110. As stated above, the scanner 150/sensor 145 may be embodied by an optical scanner, digital camera, photoelectric sensors, spectral sensors, ultrasonic sensors, and the like. In one embodiment, the scanner 150 is capable of detecting non-visible (to the human eye) light such as infrared light and UV light and/or visible light. Consequently, the projector 110 may project the authorization pattern using non-visible light detected by the pattern recognition module 400 and undetectable to people passing by the projection surface.

In one embodiment, the scanner 150 is a digital camera which captures an image of the projection surface 120. The pattern recognition module 400 may analyze the image using image recognition methods known in the art to recognize the authorization pattern.

The authorization pattern may include a pattern generated by the projector 110 and/or projector controller 105 based on authorization pattern information communicated to authorized projectors 110. In one embodiment, the authorization pattern information may include an image of the authorization pattern and/or specification of the authorization pattern for the projector 110 to project. In certain embodiments, the authorization pattern information includes an algorithm and the projector 110/projector controller 105 may generate the authorization pattern based on the algorithm. The algorithm may change at a predetermined interval. In one embodiment, the algorithm is a checksum algorithm. In a further embodiment, the projector 110/projector controller 105 may use the checksum algorithm in conjunction with a video stream of the projection image itself, segments of video, and the like to generate the authorization pattern.

Furthermore, the pattern recognition module 400 may recognize the authorization pattern using the algorithm. Specifically, the pattern recognition module 400 may use the algorithm to interpret scanned images and/or visual feedback from the sensor 145/scanner 150 in recognizing the authorization pattern, comparing the scanned images of the projection surface with an acceptable authorization pattern. In one embodiment, the pattern recognition module 400 uses fuzzy logic to evaluate scanned images. In this embodiment, if the scanned images approximate an acceptable authorization pattern within a certain threshold, the pattern recognition module 400 may recognize the authorization pattern and signal the determination module 305 to authorize the projector 110.

The identifier module 405 validates a projector identifier. Specifically, in one embodiment, the authorization pattern includes a projector identifier comprising a unique identifier for a projector 110 and/or projector controller 105. The determination module 305 may determine that the projector 110 is authorized to project the projected image 125 on the projection surface 120 in response to the identifier module 405 validating the projector identifier from the projector 110. For example, if a particular projector 110 and corresponding projector controller 105 is authorized to project on the projection surface 120, the identifier module 405 may maintain a record of a projector identifier for the particular projector 110 and/or corresponding projector controller 105. The projector 110 may project the projector identifier onto the projection surface 120 and the identifier module 405 may recognize the projector identifier and validate the projector identifier. The identifier module 405, like the pattern recognition module 400, may include and/or be in communication with the scanner 150 and/or sensor 145 to scan the projection surface 120 for the project identifier projected from the projector 110.

The projector identifier may include a Media Access Control (“MAC”) address, Internet Protocol (“IP”) address, and/or other suitable identifier of the projector 110 and/or projector controller 105. The projector identifier may also include a subscriber identifier, advertiser identifier, and/or other identifiers assigned by the identifier module 405.

The communication module 410 communicates authorization pattern information to the projector 110/projector controller 105 and, as stated above, the projector 110/projector controller 105 generates the authorization pattern based on the authorization pattern information. In one embodiment, if the authorization pattern information includes an algorithm, the communication module may communicate the algorithm to the projector 110 and the projector 110 may generate the authorization pattern based on the algorithm. The communication module 410 may communicate with the projector 110/projector controller 105 using a network connection (e.g. a wired and/or wireless connection), a direct cable connection, and/or other suitable means of communication. In one embodiment, the communication module 410 communicates authorization pattern information at a point in time before the projector 110 begins projecting a projected image 125. Furthermore, in certain embodiments, the communication module 410 communicates authorization pattern information in response to a user making a rental payment, entering in a password, and the like.

The projection module 415 projects, with one or more second projectors 140, a second projected image 210 over at least a portion of the display of the projected image 125. In one embodiment, the second projected image 210 includes an interfering image that interferes with at least a portion of the display of the projected image 125. For example, the second projector 140 may project a second projected image 210 that renders the projected image un-viewable, produces a message across the projected image 125, and/or distorts the projected image 125.

As described in relation to FIG. 2, in certain embodiments, the projection module 415 projects one or more additive colors in the second projected image 210 and the additive colors mix with one or more colors of the display to neutralize at least a portion of the display. As stated above, neutralizing the display may include changing the display or a portion of the display to substantially white or to another solid color, producing a pattern on the display, and the like. The projection module 415 may project particular additive colors on top of particular colors in the projected image 125 to neutralize the particular colors; each particular additive color may be determined, as described below, to specifically correspond to a particular projected color to produce a desired effect (e.g. neutralization or color modification). The projection module 415 may receive, retrieve, and/or otherwise reference additive color information from the additive color determination module 430 as described below.

The projection module 415 may configure the second projected image 210 to have similar dimensions as the projected image 125. Furthermore, in one embodiment, the projection module 415 may control the movement and/or position of the second projector 140 including and lens changes and the like, to approximate position and/or size of the projected image 125. Furthermore, as described below, the projection module 415 may adapt the second projected image 210 and/or the projection module 415 may project multiple images, such as in a video stream, to neutralize a projected image 125 that includes changing images and/or a video stream.

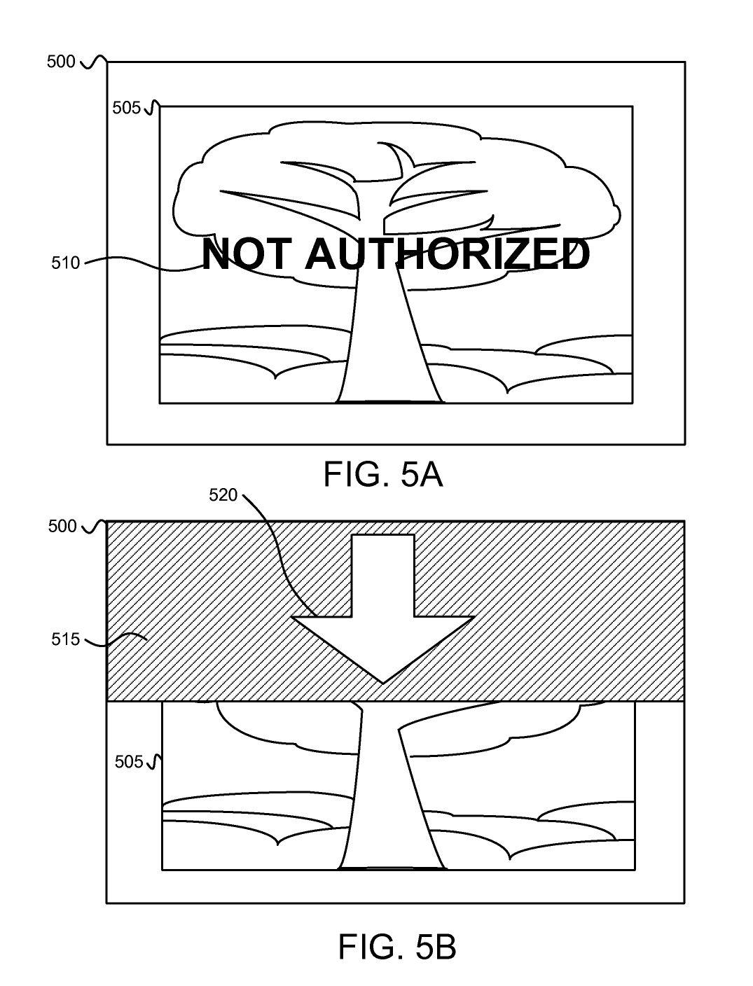

Referring also to FIG. 5A, in one embodiment, additive colors in the second projected image 210 may produce a message 510 and/or symbol across the projected image 505 on the projection surface 500. In FIG. 5A, additive colors in the second image mix with colors of the projected image 505 to produce the words “NOT AUTHORIZED” 510 in a particular color across the projected image 505.

Referring back to FIG. 4, to generate additive colors as described, the interference module 310 may include the scanner module 420. The scanner module 420 scans the display of the projected image on the projection surface 120. The scanner module 420 may include and/or be in communication with the scanner 150 and/or sensor 145 to scan the projection surface 120 for the project identifier projected from the projector 110. As described above, the scanner 150 may include various scanners such as optical scanners, digital cameras, and the like.

The scanner 150 may record information concerning the projected image size, position, and the like. In one embodiment, the scanner 150 records an image and/or continuous video stream of the projected image 125.

The color determination module 425 determines a displayed color at each of a plurality of locations of the display. Each displayed color, in one embodiment, may be represented by a Red Green Blue (“RGB”) and/or hexadecimal (“HEX”) numeric value color code. An RGB value may be represented by a number for red, a number for green, and a number for blue. For example, an exemplary RGB value may be “(176, 23, 31)”.

The color determination module 425 may analyze the scan of the projected image 125 and record a displayed color value at locations across the display of the projected image 125. The color determination module 425 may measure the relative location of each RGB/HEX value from known points on the projection surface 120. Specifically, the color determination module 425 may begin from some point on the identified projected image 125/scanned projected image (e.g. the upper-left corner) and begin identifying the RGB/HEX value at that position; then, move across/down the projected image 125/ scanned projected image and record the RGB/HEX value at each other point. As a result, the color determination module 425 may correlate color values and locations across the projected image 125.

In one embodiment, the color determination module 425 creates, maintains, and/or updates a color map with color values for a plurality of locations across the projected image 125. The color determination module 425 may determine colors at a predetermined interval. In one embodiment, the color determination module 425 determines colors continuously, such as when the projected image 125 includes moving images or otherwise changes.

The additive color determination module 430 determines an additive color corresponding to each displayed color for each location of the plurality of locations. The additive color determination module 430 may calculate the addition of light needed to achieve the desired color on that location against the projection surface 120. For example, if the RGB value at X,Y coordinate 1,1 is a particular color of red (RBG 176, 23, 31) and the desired color for that position is “white” (255, 255, 255), then the appropriate RBG value would be projected on that position by subtracting the red value from the “white” value. In one embodiment, the additive color determination module 430 receives and/or otherwise references the color map from the color determination module 425 in determining additive colors. Furthermore, in one embodiment, the additive color determination module 430 creates, maintains, and/or updates a color map with additive color values for the plurality of locations across the projected image 125. The additive color determination module 430 may determine additive colors at a predetermined interval. In one embodiment, the additive color determination module 430 determines additive colors continuously, such as when the projected image 125 includes moving images. The projection module 415 may then project the second image using the additive colors determined by the additive color determination module 430.

The surface alteration module 435 alters the projection surface 120 itself. For example, referring to FIG. 5B, the surface alteration module 435 may control a mechanism to move 520 a covering 515 across the projection surface 500 over the projected image 505. The covering 515 may comprise non-reflective material, material that absorbs light, and the like. Referring back to FIG. 4, the surface alteration module 435 may control a mechanism to open one or more openings in the projection surface 120 (e.g. window blind-like behavior). In one embodiment, the projection surface 120 comprises switchable glass that turns opaque in response to an internal electrical current as is known in the art. In this embodiment, the surface alteration module 435 may switch the projection surface 120 (e.g. by controlling a mechanism to activate a current in the glass) to transparent to disrupt the projected image 125. The surface alteration module 435 may user any suitable method to alter the projection surface 120.

The projector communication module 440 of the projector 110/projector controller 105 may communicate with the master controller 130 and/or the projection management apparatus 135. In one embodiment, the projector communication module 440 receives authorization pattern information. As stated above, the authorization pattern information may be communicated from the master controller 130/projection management apparatus 135 and may include an image of the authorization pattern and/or specification of the authorization pattern for the projector 110 to project. In certain embodiments, the authorization pattern information includes an algorithm.

The pattern generation module 445 of the projector 110/projector controller 105 generates the authorization pattern based on the authorization pattern information. The pattern generation module 445 may generate the authorization pattern based on an algorithm when the authorization pattern information includes the algorithm. As stated above, the authorization pattern may include a symbol, character, character string, and/or other suitable pattern. The authorization pattern may include a single symbol and/or pattern, or multiple symbols/patterns displayed in sequence.

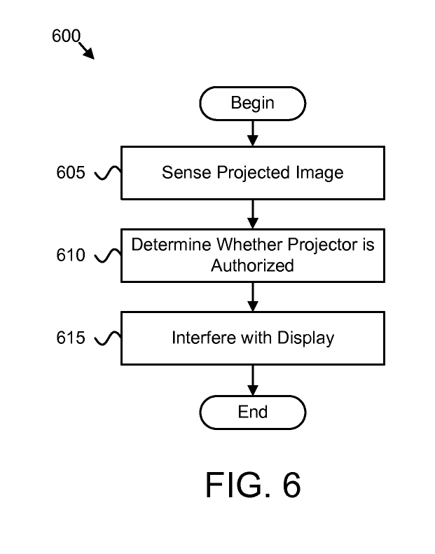

FIG. 6 illustrates one embodiment of a method 600 for managing projected images 125 on a projection surface 120. The method 600 substantially includes the steps to carry out at least a portion of the functions presented above with respect to the operation of the described apparatus and systems of FIGS. 1-3. The description of the method 600 refers to elements of FIGS. 1-3, like numbers referring to like elements.

The method 600 starts and the sensor module 300 senses 605 a projected image 125 displayed on a projection surface 120. The projected image 125 is projected from a projector 110. The determination module 305 determines 610 whether the projector 110 from which the projected image 125 originates is authorized to project the projected image 125 on the projection surface 120. The interference module 310 interferes 615 with a display of the projected image 125. The interference module 310 interferes with the display by altering the display of at least a portion of the projected image 125. Then, the method 600 ends.

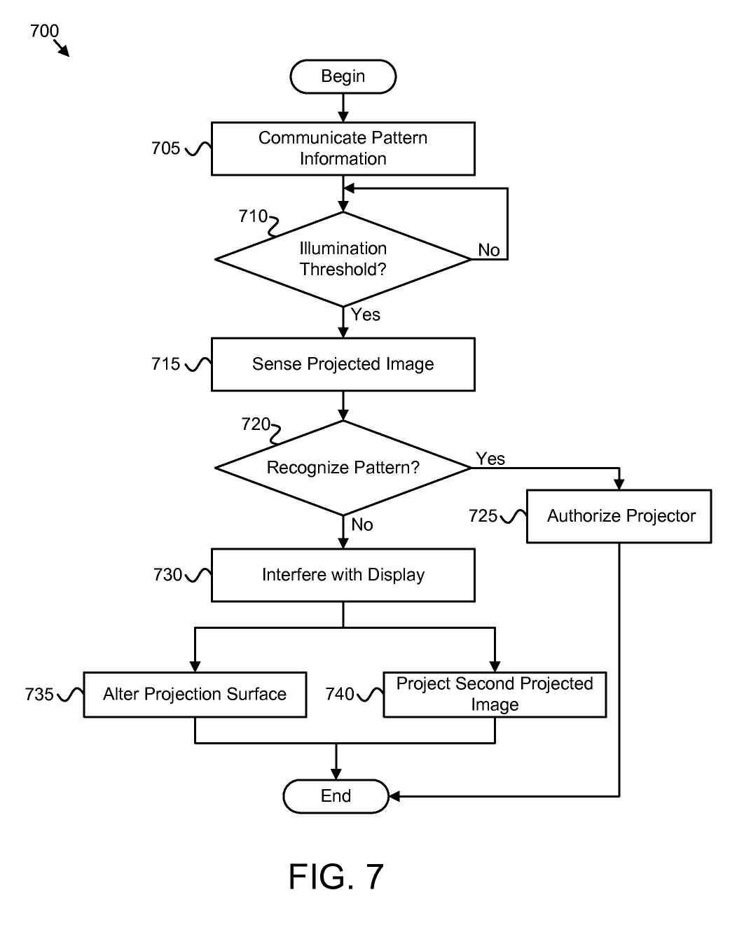

FIG. 7 illustrates another embodiment of a method 700 for managing projected images 125 on a projection surface 120. The method 700 substantially includes the steps to carry out at least a portion of the functions presented above with respect to the operation of the described apparatus and systems of FIGS. 1-4. The description of the method 700 refers to elements of FIGS. 1-4, like numbers referring to like elements.

The method 700 starts and the communication module 410 communicates 705 authorization pattern information to one or more projectors 110/projector controllers 105. For example, a user of a particular projector 110 may pay a fee to project on the projection surface 120 over a web interface and the communication module 410 may communicate authorization pattern information in response to the user paying the fee. Next, the sensor module 300 continually senses 710 for an illumination above a threshold on the projection surface 120. If the sensor module 300 senses 710 illumination above a threshold, the sensor module 300 senses 715 a projected image 125.

Next, if the pattern recognition module 400 recognizes 720 an authorization pattern projected from the projector 110, the determination module 305 determines 725 that the projector 110 is authorized to project the projected image 125 and the method 700 ends.

Alternatively, if the pattern recognition module 400 does not recognize 720 any authorization pattern in the projected image 125, the interference module 310 interferes 730 with a display of the projected image 125. In one embodiment, the surface alteration module 435 alters 735 the projection surface 120. For example, the surface alteration module 435 may move a covering across the projection surface 120, switch the projection surface 120 to transparent if the projection surface 120 is switchable glass, opening openings in the projection surface 120, and the like. Alternatively, the projection module 415 projects 740, with a second projector, a second projected image 210 over at least a portion of the display of the projected image 125. The second image may comprise an interfering image that interferes with at least a portion of the display of the projected image 125. Furthermore, second image may include additive colors that mix with one or more colors of the display to neutralize at least a portion of the display. Then, the method 700 ends.

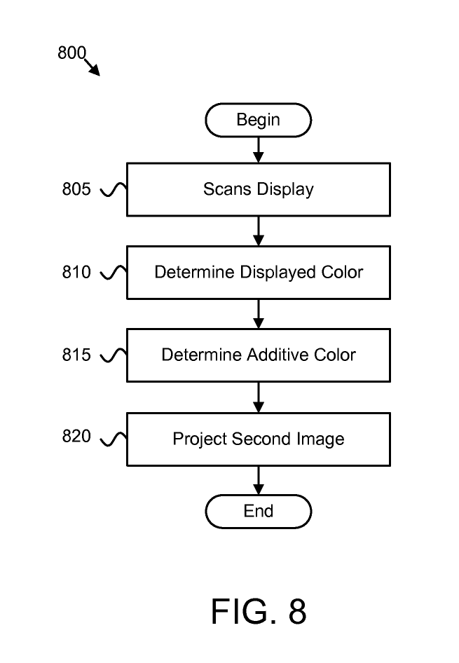

FIG. 8 illustrates one embodiment of a method 800 for interfering with a projected image 125 on a projection surface 120. The method 800 substantially includes the steps to carry out at least a portion of the functions presented above with respect to the operation of the described apparatus and systems of FIGS. 1-4. The description of the method 800 refers to elements of FIGS. 1-4, like numbers referring to like elements.

The method 800 starts and the scanner module 420 scans 805 the display on the projection surface 120. Next, the color determination module 425 determines 810 a displayed color at each of a plurality of locations of the display. The additive color determination module 430 then determines 815 an additive color corresponding to each displayed color for each location of the plurality of locations. The projection module 415 then projects 820 the one or more additive colors in the second projected image 210. Then, the method 800 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for managing projected images on a projection surface, the apparatus comprising:
a sensor module that senses a projected image displayed on a projection surface, the projected image projected from a projector;
a determination module that determines whether the projector is authorized to project the projected image on the projection surface in response to the sensor module sensing the projected image projected on the projection surface; and
an interference module that interferes with a display of the projected image in response to the determination module determining that the projector is not authorized to project the projected image on the projected surface, wherein the interference module alters the display of at least a portion of the projected image.

2. The apparatus of claim 1, wherein the determination module further comprises a pattern recognition module that recognizes an authorization pattern projected from the projector onto the projection surface, wherein the determination module determines that the projector is authorized to project the projected image on the projection surface in response to the pattern recognition module recognizing the authorization pattern projected from the projector onto the projection surface.

3. The apparatus of claim 2, further comprising a communication module that communicates authorization pattern information to the projector, wherein the projector generates the authorization pattern based on the authorization pattern information.

4. The apparatus of claim 3, wherein the authorization pattern information comprises an algorithm and wherein the communication module communicates the algorithm to the projector, wherein the projector generates the authorization pattern based on the algorithm, wherein the pattern recognition module recognizes the authorization pattern using the algorithm.

5. The apparatus of claim 3, further comprising a projector communication module that receives authorization pattern information and a pattern generator module that generates the authorization pattern based on the authorization pattern information.

6. The apparatus of claim 2, wherein the authorization pattern comprises a projector identifier, the apparatus further comprising an identifier module that validates the identifier, wherein the determination module determines that the projector is authorized to project the projected image on the projection surface in response to the identifier module validating the projector identifier from the projector.

7. The apparatus of claim 1, wherein the interference module further comprises a projection module that projects, with a second projector, a second projected image over at least a portion of the display of the projected image.

8. The apparatus of claim 7, wherein the projection module projects one or more additive colors in the second projected image wherein the additive colors mix with one or more colors of the display to neutralize at least a portion of the display.

9. The apparatus of claim 8, wherein the interference module further comprises:
a scanner module that scans the display on the projection surface;
a color determination module that determines a displayed color at each of a plurality of locations of the display;
an additive color determination module that determines an additive color corresponding to each displayed color for each location of the plurality of locations; and
wherein the projection module projects the one or more additive colors in the second projected image.

10. The apparatus of claim 7, wherein the second image comprises an interfering image that interferes with at least a portion of the display of the projected image.

11. The apparatus of claim 1, wherein the sensor module senses the projected image displayed on the projection surface in response to an illumination above a threshold.

12. The apparatus of claim 1, wherein the interference module further comprises a surface alteration module that alters the projection surface by one or more of moving a covering across the projection surface, switching the projection surface to transparent wherein the projection surface comprises switchable glass, and opening one or more openings in the projection surface.

13. The apparatus of claim 1, wherein the interference module stops interfering with the display of the projected image in response to the determination module determining that the projector is authorized to project the projected image on the projected surface.

14. The apparatus of claim 1, wherein the determination module determines whether the projector is authorized based on one or more of a time of day, a rental plan, an identity of the projector, and an identity of one or more viewers.

15. A method for managing projected images on a projection surface, the method comprising:
sensing a projected image displayed on a projection surface, the projected image projected from a projector;
determining whether the projector is authorized to project the projected image on the projection surface in response to sensing the projected image projected on the projection surface; and
interfering with a display of the projected image in response to determining that the projector is not authorized to project the projected image on the projected surface, wherein interfering with the display further comprising altering the display of at least a portion of the projected image.

16. The method of claim 15, wherein determining whether the projector is authorized to project the projected image further comprises recognizing an authorization pattern projected from the projector onto the projection surface and determining that the projector is authorized to project the projected image on the projection surface in response to recognizing the authorization pattern projected from the projector onto the projection surface.

17. The method of claim 16, further comprising communicating authorization pattern information to the projector, wherein the projector generates the authorization pattern based on the authorization pattern information.

18. The method of claim 15, further comprising projecting, with a second projector, a second projected image over at least a portion of the display of the projected image.

19. The method of claim 18, further comprising:
scanning the display on the projection surface;
determining a displayed color at each of a plurality of locations of the display;
determining an additive color corresponding to each displayed color for each location of the plurality of locations; and
wherein projecting a second projected image further comprises projecting the one or more additive colors in the second projected image wherein the additive colors mix with one or more colors of the display to neutralize at least a portion of the display.

20. A system for managing projected images on a projection surface, the system comprising:
a sensor;
one or more processors in communication with the sensor;
a sensor module executing on at least one of the processors, the sensor module for sensing, using the sensor, a projected image displayed on a projection surface, the projected image projected from a projector;
a determination module executing on at least one of the processors, the determination module for determining whether the projector is authorized to project the projected image on the projection surface in response to the sensor module sensing the projected image projected on the projection surface; and
an interference module executing on at least one of the processors, the interference module for interfering with a display of the projected image in response to the determination module determining that the projector is not authorized to project the projected image on the projected surface, wherein the interference module alters the display of at least a portion of the projected image.
